(19) United States
(12) Patent Application Publication
(10) Pub. No.: US 2008/0178472 A1
(43) Pub. Date: Jul. 31, 2008

(54) SCISSORS

(75) Inventors: Werner Abele, Bohmenkirch (DE); Werner Mang, Geislingen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WMF WURTTEMBERGISCHE METALLWARENFABRIK AG, Geislingen (DE)

(21) Appl. No.: 11/877,041

(22) Filed: Oct. 23, 2007

(30) Foreign Application Priority Data
Oct. 25, 2006 (EP) 06022339.3

(51) Int. Cl. B26B 13/16; B26B 13/00

(52) U.S. Cl. 30/262; 30/271

(57) ABSTRACT

Scissors comprising two scissor components, which are connected via a pivot, and a spring whose spring effect forces the two scissor components apart into an open position. In order to make such scissors more universally usable, means (10) for disabling the spring effect are also provided.

### CROSS-REFERENCE TO RELATED APPLICATION

The present application claims the benefit of priority of European Patent Application No. 06022339.3, filed Oct. 25, 2006. The entire text of the priority application is incorporated herein by reference in its entirety.

### FIELD OF DISCLOSURE

The present disclosure refers to scissors of the type that have spring effect.

Spring-loaded scissors are known in great variety and are used e.g. in the spheres of household, garden or hobbies. Spring-loaded scissors of the above-defined type have been described e.g. in DE 91 01 488. The known scissors comprise a torsion spring that winds around the pivot bolt about which the two scissor components are pivoted relative to one another. The respective ends of the torsion spring rest on the respective scissor components, the spring being tensioned when the scissor components are closed for the purpose of cutting; when the handle parts are released after cutting, the scissor components follow the user's hand that opens, so that the user need not manually reopen the scissor components prior to carrying out the next cut. There are, however, cutting tasks in the case of which it will be of advantage when the scissor components are guided sensitively also during the return movement, especially when precise cuts are desired. In the case of the known spring-loaded scissors, the user looses control, to a certain extent, when he opens the scissors under the spring effect so that precise cutting will be more difficult.

### SUMMARY OF DISCLOSURE

It is the object of the present disclosure to provide scissors which are universally handable and which also allow precise cuts.

On the basis of the embodiment according to the present disclosure, the user himself can decide whether he desires that the scissors will open automatically after a cut, or whether he wants to keep control over the movement of the scissor components in all the phases of the cutting process. For comparatively rough or heavy cuts, e.g. when the scissors are used as poultry shears, the user can switch on the spring effect so that he will have to apply a force to the scissors only during the actual cutting process. If the scissors are to be used for more difficult tasks, e.g. for cutting figures out from paper or the like, the spring effect can be disabled so that the user will actively determine the movement of the scissor components in all phases, i.e. during the actual cut as well as during the return movement of the scissor components before the next cut is carried out.

The disabling is preferably carried out by a displacement movement by means of which the spring and a stop are moved relative to one another, since displacement movements can be carried out easily, e.g. with the thumb or with some other finger of one hand, without it being necessary that the user loosens his hold on the scissors. The displacement movement can be a linear movement as well as a movement that follows a curve.

The spring used is preferably a leaf spring, since these springs can be accommodated without taking up too much space.

A possibility of disabling the spring effect, which is particularly simple from the structural point of view and which is therefore preferably used, is an arrangement in which the spring is associated with one scissor component and provided such that it acts against a stop associated with the other scissor component; only when the spring effect is to be enabled, it must then be guaranteed that engagement between the spring and the stop does not take place.

A stripshaped or wireshaped leaf spring is particularly simple to produce and can be bent into any desired shape so that said spring can then easily be associated also with narrow scissor components.

According to a preferred embodiment, the spring is displaceably accommodated in a scissor component so that it will not be in the way during the cutting operation.

Although it is possible to displace the spring directly, a slide is preferably provided, said slide having the spring secured thereto. With the aid of said slide, it is structurally simpler to enforce a defined movement of the spring for disabling the spring effect.

When said slide is not used as an actuating element itself, but connected to a separate actuating element, mounting of the scissors will be facilitated still further.

According to a preferred embodiment, a safety means is provided for fixing the disabled position so that the user, when using the scissors with disabled spring effect, need neither continuously hold nor constantly reestablish said disabled position.

The safety means is preferably activated by the same actuating element which is also used for disabling the spring effect. In this way, the handling of the scissors will be improved still further.

### BRIEF DESCRIPTION OF THE DRAWINGS

In the following, an embodiment of the present disclosure will be explained in more detail on the basis of the drawings, in which:

FIG. 1 shows a top view of scissors under spring load, part of said top view being a sectional view,

FIG. 2 shows the section II-II according to FIG. 1,

FIG. 3 shows a representation of the scissors, similar to FIG. 1, in which the spring effect has been disabled,

FIG. 4 shows the section IV-IV according to FIG. 3,

FIG. 5 shows the section V-V according to FIG. 1, and

FIG. 6 shows a view of an actuating element from below.

### DETAILED DESCRIPTION

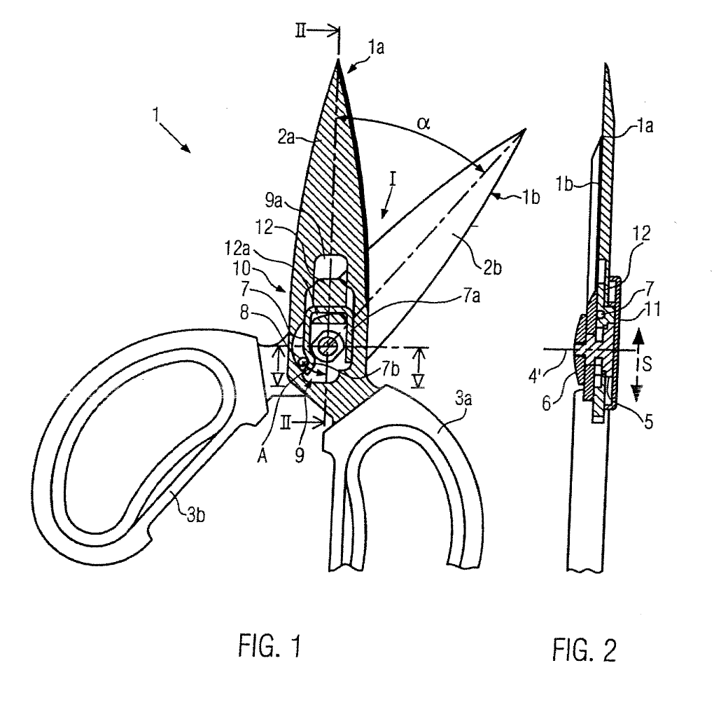

FIG. 1 to 6 show scissors 1 which are implemented according to the present disclosure and which are adapted to be used as hand-operated scissors for private use in the household or in the garden, or for use in offices, restaurant kitchens or other kitchens, in gardens or in nurseries or the like. The scissors 1 according to the present disclosure are suitable to be used for rough cuts, which will be necessary when the scissors are used e.g. as poultry shears or branch cutting shears, as well as for precise cuts, which are carried out e.g. for cutting paper.

The scissors 1 comprise two scissor components 1a and 1b, which, as is normally the case, each comprise a cutting blade 2a, 2b and a handle area 3a, 3b. In the embodiment shown, the handle areas 3a, 3b are each implemented as a handle eye so that the cutting blades 2a, 2b can be opened as easily as possible even without spring support. The handle areas may, however, also be designed in some other way.

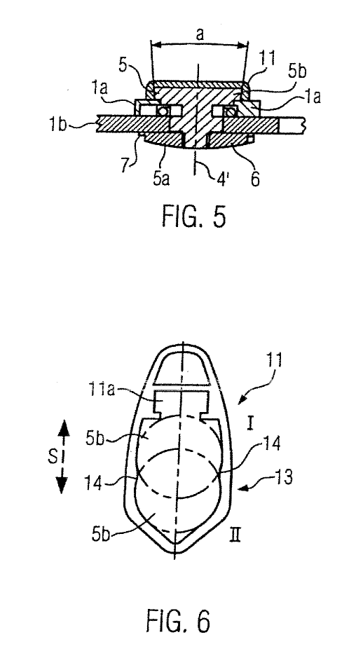

The two scissor components 1a, 1b are adapted to be pivoted about a hinge 4 with a pivot 4′ between the cutting blades 2a, 2b and the handle areas 3a, 3b. The pivot 4′ is, as is usually the case, defined by a shaft area 5a of a of a mounting bolt 5 which, in combination with a suitable nut 6, secures the two scissor components 1a, 1b to one another (cf. FIG. 5).

A spring 7 is arranged between the two scissor components 1a, 1b. The spring 7 rests via a support area 7a on the first scissor component 1a, and it is adapted to be moved together with said first scissor component 1a. The second scissor component 1b has connected thereto a stop 8 which moves together with said second scissor component 1b. The spring 7 comprises an engagement area 7b which is in engagement with the stop 8 in a load position I (FIG. 1). When the engagement area 7b of the spring 7 is in engagement with the stop 8, the stop 8 will be moved in the direction of the arrow A and the spring 7 will be tensioned when the scissors 1 perform a cutting movement, i.e. when the two scissor components 1a, 1b move towards each other. When the user reduces the pressure applied to the handle areas 3a, 3b, the scissor components 1a, 1b will be forced apart under the effect of said spring 7 so that the handle area will follow the user's hand that opens. In so doing, the spring 7 will release. The spring 7 is tensioned at a predetermined opening angle α, which is smaller than the maximum possible opening angle predetermined by the hinge and which amounts to approx. 40° in the embodiment shown. It follows that, beyond said opening angle α, the spring is not tensioned.

In the embodiment shown, the spring 7 is a leaf spring (wire spring) having preferably a round cross-section which can easily be bent from a piece of spring wire. In the embodiment shown, the spring 7 is bent into a substantially U-shaped configuration and accommodated in an opening 9 in the first scissor component 1a. The spring 7 rests, via its support area 7a on one of its free ends, on the wall of the opening 9. The other free end, which is provided with the engagement area 7b, projects freely into said opening 9 and includes in said engagement area preferably a hook-shaped, bent portion whose inner size is adapted to the outer size of the stop 8.

The scissors 1 according to the present disclosure additionally comprise a means 10 with the aid of which the engagement between the stop 8 and the spring 7 can be released so that the scissor components 1a, 1b can be opened also within the opening angle α under control and by actuation of the user. The means 10 is implemented as a slide means and comprises an actuating element 11 which is arranged within easy reach of one of the user's fingers, i.e. it is preferably arranged in the area of the hinge 4. The actuating element 11 is supported for sliding actuation, preferably linearly, in the direction of the double arrow S. In the embodiment shown, this is accomplished in that the actuating element 11 is slidably arranged via a snap-on connection, e.g. by guide surfaces which are undercut in a dovetail-like fashion, on a head 5b of the pivot bolt 5, so that said head 5b serves as a guide means for the actuating element 11. The spring 7 is connected to the actuating element 11 so that it will be entrained when the actuating element 11 is displaced along the arrow S.

The connection between the spring 7 and the actuating element 11 is preferably established via a slide 12 provided with a groove 12a into which the spring 7 is pressed and which allows the spring to move when it is being tensioned and released. The slide 12 runs in a guide opening 9a which defines an extension of the opening 9 in which the stop 8 moves. The slide 12 is held in an opening 11a of the actuating element 11 in such a way that it will be entrained by a movement of said actuating element 11.

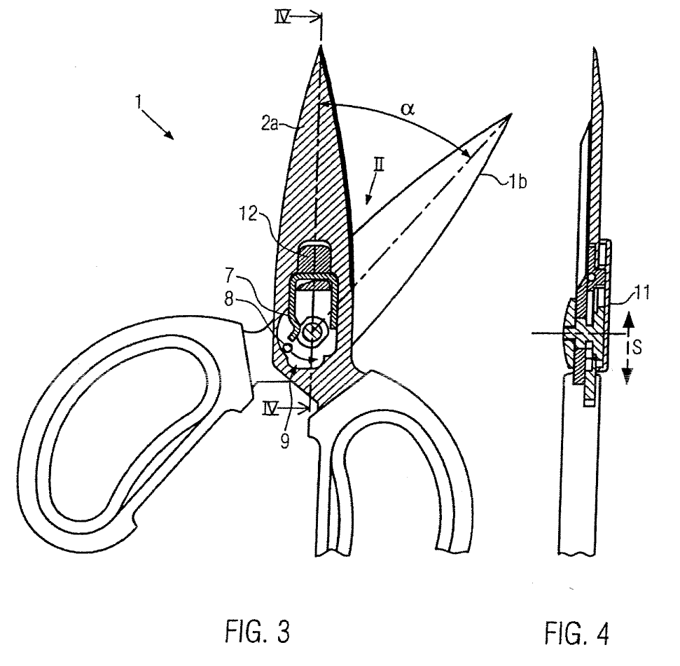

By displacing the actuating element 11 in the direction of the arrow S to the position shown in FIGS. 3 and 4, i.e. in the direction of the cutting blades 2a, 2b, the slide 12 is pushed into the guide means 9a and entrains the spring 7 in this way. The possibility of displacement is dimensioned such that the spring 7 will be displaced from the engagement area of the stop 8 when the slide 12 occupies its uppermost position.

The spring 7 is thus disabled, i.e. the stop 8 can move freely in the opening 9 without tensioning the spring 7, when the scissor components 1a, 1b are closed. This has the effect that the spring 7 is no longer tensioned, i.e. the scissor components 1a, 1b must be opened by the user before the next cut is carried out. The spring 7 remains in the disabled position II shown in FIG. 3 until it is pushed back to the load position I shown in FIG. 1.

The actuating element 11 is simultaneously implemented as a cover for the opening 9, the guide means 9a and the parts provided therein, so that these parts will be prevented from becoming dirty and so that the scissors can be cleaned more easily.

In addition, a safety means 13 is provided, which fixes either one or both positions I, II such that the scissors cannot be moved inadvertently from one position to the other, but can be adjusted by the user easily and without major effort, preferably with one finger. The safety means 13 is preferably associated with the actuating element 11 and comprises a projection 14 which, on the guide surface of the actuating element 11 towards the head 5b of the pivot bolt 5, protrudes towards said head 5b. The actuating element, or at least the projection 14, is able to give way elastically, i.e. the projection 14 consists either of an elastically compressible material, such as an elastomer, rubber or some other elastically deformable material, or it is movably fastened, e.g. on a support that gives way elastically, e.g. on an actuating element wall which will curve outward. The projection 14, which is preferably provided on both sides of the actuating element 11 in a symmetrical fashion, projects into the guide means to such an extent that the free space becomes smaller than the dimension of the diameter α of the head 5b. The projection 14 does, however, not project into the guide means to such an extent that it could not be overcome by a displacement movement of the actuating element 11 caused by normal finger pressure. The projection 14 is located at a position along the displacement path S outside of the contact area between the head 5b and the guide surfaces on the actuating element 11, when the head 5b occupies a respective one of the load position I and disabled position II. In other words, the projection 14 is located at a position between the two end positions of the head 5b. This has the effect that the actuating element 11 is protected against inadvertent displacement in each of the positions I, II.

Any other spring-effect disabling means can be used as a modification of the above-described and specified embodiments. One possibility is, for example, to move the stop instead of the spring. The linear displacement movement can also be replaced by a rotary or a pivotal one. The spring could e.g. also be disabled by a displacement along the pivot.

1. Scissors (1), comprising two scissor components (1a, 1b), which are connected via a pivot (4′), a spring (7) whose spring effect forces the two scissor components (1a, 1b) apart into an open position, and means (10) for disabling the spring effect.

2. Scissors according to claim 1, wherein the means for disabling (10) comprises a slide means for relative displacement between the spring (7) and a stop (8) between a load position (I) and a disabled position (II).

3. Scissors according to claim 1, wherein the spring (7) is a bent leaf spring.

4. Scissors according to claim 1, wherein the spring (7) rests on one scissor component (1a) and acts against a stop (8) provided on the other scissor component (1b).

5. Scissors according to claim 1, wherein the spring (7) is displaceably accommodated in an opening (9) provided in one of the scissor components (1a).

6. Scissors according to claim 1, wherein the spring (7) is implemented as an elongate element and rests via one end (7a) on one of the scissor components (1a), that, in a load position (I), it engages with its other end (7b) a stop (8) provided on the other scissor component (1b), so as to be tensioned when the scissor components (1a, 1b) carry out a cutting movement, and that it is adapted to be moved to a disabled position (II) by a relative movement between the stop (8) and the spring (7).

7. Scissors according to claim 1, wherein the spring (7) is secured to a slide (12).

8. Scissors according to claim 7, wherein the slide (12) is connected to an actuating element (11).

9. Scissors according to claim 1, and a safety means (13) is provided for fixing the disabled position (II).

10. Scissors according to claim 9, wherein the means (10) for disabling the spring effect comprise an actuating element (11) which is implemented as an actuating element of the safety means (13).
